(19) United States
(12) Patent Application Publication
(10) Pub. No.: US 2010/0005837 A1
(43) Pub. Date: Jan. 14, 2010

(54) METHOD OF MANUFACTURING AN ELONGATED GLASS BODY

(76) Inventors: Tetsuya Nakanishi, Kanagawa (JP); Ryouji Hishikura, Kanagawa (JP)

Correspondence Address: MCDERMOTT WILL & EMERY LLP, 600 13TH STREET, N.W., WASHINGTON, DC, 20005-3096, US

(21) Appl. No.: 12/444,679

(22) PCT Filed: Jun. 13, 2008
(86) PCT No.: PCT/JP2008/060820

§ 371 Date: Apr. 7, 2009

(30) Foreign Application Priority Data
Jun. 25, 2007 (JP) 2007-166784

(51) Int. Cl. C03B 37/07

(52) U.S. Cl. 65/382

(57) ABSTRACT

A method of manufacturing an elongated glass body by elongating a glass body of columnar or cylindrical shape. The method comprises: (1) a first elongating step for obtaining an intermediate elongated body, where the glass body is softened by heating and elongated, while the diameter of the softened part is measured, so that the measured value may become equal to a first controlled diameter which is larger than the target diameter, where the diameter of the intermediate elongated body satisfies the relationship at each position thereof: (the target diameter−10 μm)<(the diameter of the intermediate elongated body)<(the target diameter+500 μm); and (2) a second elongating step for obtaining an elongated glass body having the target diameter, where the intermediate elongated body is softened by heating and elongated.

### TECHNICAL FIELD

The present invention relates to a method of manufacturing an elongated glass body.

### BACKGROUND ART

An optical fiber that is manufactured by drawing an optical fiber preform has characteristics that depend on the refractive index profile along the radius of the preform. As the required precision of the characteristics of an optical fiber has become higher, so has the precision required of the refractive index profile of the optical fiber become higher. Thus, in order to respond to such requirement, there has been a demand for a method with which an optical fiber preform having a desired refractive index profile can be manufactured.

Also, higher precision is required in the elongation process of an intermediate preform, which is one step of the process for manufacturing an optical fiber preform. WO2004/000740 (Patent Document 1) discloses an invention for controlling the elongation rate on the basis of the outer diameter of an intermediate preform as measured during the elongation of the intermediate preform so that an optical fiber preform having an outer diameter that is uniform in the longitudinal direction can be obtained.

However, with the method disclosed in that invention, the outer diameter of the elongated optical fiber preform varies in the longitudinal direction very much, resulting in difficulty of obtaining a desired refractive index profile at each position along the longitudinal direction. Also, SiO₂ that exists in the surface of the intermediate preform evaporates as Si—OH and Si—H gases because of heating during the elongation. The higher the heating temperature, the larger the quantity of the vaporization becomes. Accordingly, the outer diameter is decreased, resulting in degradation in the precision of the post-elongation outer diameter. These problems arise not only in the process of elongating the intermediate preform during the manufacturing process of an optical fiber preform, but also in the process of elongating a columnar or cylindrical glass body in general.

[Patent document 1] WO2004/000740

### DISCLOSURE OF THE INVENTION

### Problem to be Solved by the Invention

The object of the present invention is to provide methods for manufacturing an elongated glass body such that the desired outer diameter can be achieved at each position along the longitudinal direction of the elongated glass body produced by elongation.

### Means for Solving the problem

In order to achieve the object, a method of manufacturing an elongated glass body having a target outer diameter is provided. In the method, a glass body of columnar or cylindrical shape is softened by means of heating with a heating source movable in a longitudinal direction of the glass body and is elongated to have a target outer diameter. (The target outer diameter may be constant over the entire length of the elongated glass body, or may be varied in the longitudinal direction corresponding to each position of the elongated glass body.) This method comprises a first elongating step for obtaining an intermediate elongated body and a second elongating step for obtaining an elongated glass body having the target outer diameter:

(1) in the first elongating step, the glass body is softened by heating and elongated, while the outer diameter of the softened part is measured, so that the measured value may become equal to a first controlled diameter which is larger than the target outer diameter, where the outer diameter of the intermediate elongated body satisfies the following relationship at each position thereof:

(the target outer diameter−10 μm)<(the outer diameter of the intermediate elongated body)<(the target outer diameter+500 μm);

and

(2) in the second elongating step, the intermediate elongated body is softened by heating and elongated, while the outer diameter of the softened part is measured with a first diameter monitor, so that the measure value may be equal to a second controlled diameter that is larger than the target outer diameter. Both the first controlled diameter and the second controlled diameter may be constant over the entire length of the elongated glass body corresponding to the target outer diameter, or may be varied corresponding at each position along the longitudinal direction of the elongated glass body.

In the first elongating step, it is preferable to obtain an intermediate elongated body in which the outer diameter of the intermediate elongated body satisfies the following relationship at each position thereof

(the target outer diameter)<(the outer diameter of the intermediate elongated body)<(the target outer diameter+500 μm).

In the second elongating step, preferably the distance between the starting position where the outer diameter of the intermediate elongated body commences to decrease and the position where the outer diameter is measured by the first diameter monitor is equal to or less than 1.5 times the outer diameter of the intermediate elongated body. Also, in the second elongating step, it is preferable to measure with a second diameter monitor with respect to the outer diameter of the part where the intermediate elongated body is elongated, and based on the measured outer diameter of the intermediate elongated body, to determine the distance between the position to be heated by the heating source and the position where the outer diameter is to be measured by the first diameter monitor, and to arrange the first diameter monitor based on the distance thus determined. In addition, in the second elongating step, it is preferable for the temperature of the intermediate elongated body not to exceed 1500° C.

### BRIEF DESCRIPTION OF THE DRAWINGS

FIG. 1 is a conceptional schematic diagram showing a state in which a glass body is held by an elongation machine used in the method of the present invention for manufacturing an elongated glass body.

FIG. 2 is an enlarged view of a heated part and its vicinity of an intermediate elongated body in the second elongating step according to the method of the present invention for manufacturing an elongated glass body.

FIG. 3 is a graph showing outer diameters which are respectively measured at each position along the longitudinal direction of an elongated glass body in the first example.

FIG. 4 is a graph in which the frequency distributions of two times of the standard deviation for the difference between the target outer diameter and the outer diameter of the elongated glass body in the first example are shown with respect to every difference in the outer diameter between before-elongation and after-elongation in the second elongating step.

FIG. 5 is a graph showing the outer diameter D1(X) of the intermediate elongated body and the target outer diameter D2(X) in the second example.

FIG. 6 is a graph showing the target outer diameter D2(X), the finished diameter D2′(X) of the elongated glass body, and the differences between them in the second example.

### BEST MODE FOR CARRYING OUT THE INVENTION

Hereinafter, preferred embodiments of the present invention will be described in reference to the accompanying drawings. The drawings are provided for the purpose of explaining the embodiments and are not intended to limit the scope of the invention. In the drawings, an identical mark represents the same element so that the repetition of explanation may be omitted. The dimensional ratios in the drawings are not always exact.

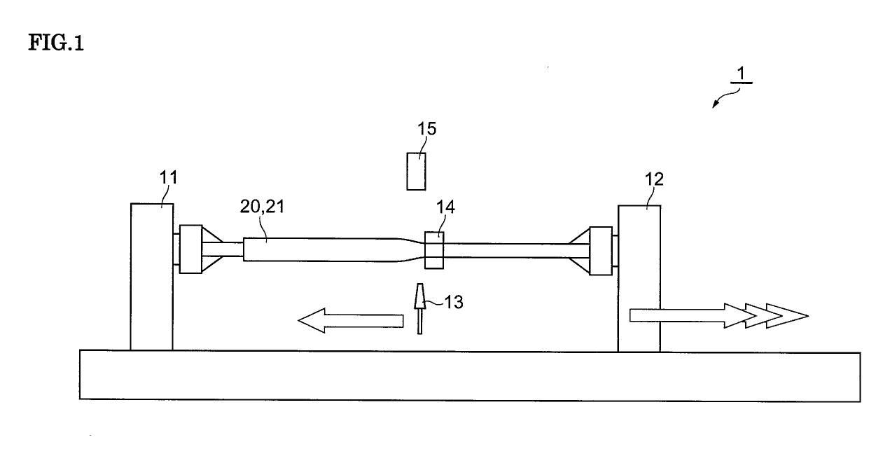

FIG. 1 is a conceptional schematic diagram showing a state in which a glass body is held by an elongation machine used in the method of the present invention for manufacturing an elongated glass body. An elongation machine 1 has a holding part 11, a holding part 12, a heating source 13, a diameter monitor 14, and a pyrometer 15. A glass body 20 is columnar or cylindrical. The glass body 20 is, for example, an optical fiber preform which includes the part to become the core of an optical fiber, or an intermediate preform on a process of manufacturing an optical fiber preform. However, the glass body 20 is not limited to them.

The glass body 20 is held in a manner such that one end thereof is held by the holding part 11 while the other end is held by the holding part 12. In such case, a glass stick (a dummy rod) for operation may be melt-bonded to each end of the glass body 20 so that these dummy rods may be held by the holding parts 11 and 12. Either one or both of the holding parts 11 and 12 can move along a straight line linking these holding parts such that the distance between the holding parts 11 and 12 can be varied.

The heating source 13, which is used for softening the glass body 20 by heating, is preferably an oxyhydrogen burner, a resistance furnace, an induction furnace, or a plasma burner. The heating source 13 is installed so as to allow changing the distance from the glass body 20 so that the range of heating the glass body 20 can be adjusted. The diameter monitor 14 measures the outer diameter of the glass body 20 in the range where the outer diameter of the glass body 20 is decreasing due to heating by the heating source 13. The pyrometer 15 measures the temperature of the heated part of the glass body 20 by non-contact measurement. The heating source 13, the diameter monitor 14, and the pyrometer 15 can respectively move in the longitudinal direction of the glass body 20. In the following description, it is assumed that for the purpose of elongating the glass body 20, the holding part 11 is fixed and the holding part 12 moves to the right while each of the heating source 13, the diameter monitors 14, and the pyrometer 15 moves from the right end of the glass body 20 toward the left end.

According to the method relating to the present invention for manufacturing an elongated glass body, the elongated glass body having a target outer diameter is manufactured by subjecting the glass body 20 to the first elongating step and the second elongating step in order.

In the first elongating step, an intermediate elongated body 21 is prepared by elongating the glass body 20. In that case, the outer diameter of the part softened by heating with the heating source 13 is measured with the diameter monitor 14, and the glass body 20 is elongated so that the measured value may have a first controlled diameter which is larger than the target outer diameter. In this manner, the intermediate elongated body 21 thus prepared is made to satisfy the formula (1):

D2(X)−10 μm<D1(X)<D2(X)+500 μm (1)

where, D1(X) is the outer diameter at a position X in the longitudinal direction of the intermediate elongated body 21, and D2(X) is the target outer diameter at the position X in the longitudinal direction of the elongated glass body.

In the second elongating step, an elongated glass body is obtained by elongating the intermediate elongated body 21. In that case, the outer diameter of the part softened by heating with the heating source 13 is measured with the diameter monitor 14, and the intermediate elongated body 21 is elongated so that the measured value may have the second controlled diameter which is larger than the target outer diameter. Thus, the elongated glass body having the target outer diameter is obtained.

If the control is done based on the outer diameter measured at a position near the finished diameter in the softened part of the glass bodies 20 and 21 (at a position that is far from the heated part), the precision in the finished diameter improves because the difference between the controlled value and the finished diameter is smaller. However, since the delay in time for the control increases, the fluctuation (the element that varies in the difference between the finished diameter and the target outer diameter) increases, and accordingly it becomes difficult to control the finished diameter with high responsiveness. In contrast, if the measurement position is set at a position far from the position of the finished diameter (at a position that is near the heated part), the responsiveness becomes better, but the precision is degraded because the difference between the value of the controlled diameter and the finished diameter becomes larger. Therefore, the trade-off relationship between the responsiveness of the control and the precision is generally put into consideration. Thus, the outer diameter is measured at the optimum position empirically discovered in the softened taper-shaped part and thereby the pulling rate for elongation is controlled.

In the second elongating step of the present invention, it is possible to shorten the distance between the elongation starting position and the elongation ending position by suppressing the decrease of the outer diameter to 500 μm, which is shown in formula (1), or less. This will solve the problem of the above-mentioned trade-off relationship and improve both the elongation precision and the responsiveness substantially so that the desired outer diameter can be obtained at each position along the longitudinal direction of the elongated glass body. More specifically, it is made possible to elongate with high precision: two times of the standard deviation σ_{D2′(X)-D2(X)} for the difference between the target outer diameter D2(X) and the finished diameter D2′(X) in the effective portion in the longitudinal direction can be made equal to or less than 40 μm. Also, it is possible to make two times of σ_{D2′(X)-D2(X)} to be equal to or less than 20 μm by controlling the decrease of the outer diameter to 250 μm or less.

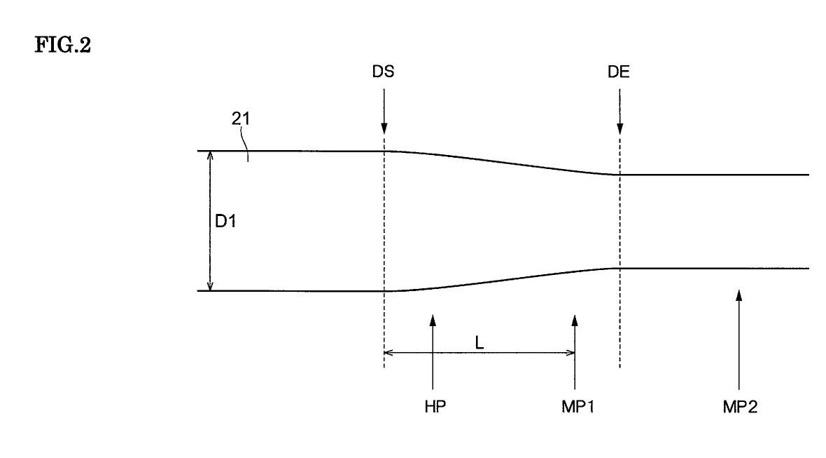

FIG. 2 is an enlarged view of a heated part and its vicinity of an intermediate elongated body at the second elongating step in the method of the present invention for manufacturing an elongated glass body. In FIG. 2, DS indicates the starting position of the outer diameter decrease; DE indicates the ending position of the outer diameter decrease; HP indicates a heating position; MP1 indicates a position where the outer diameter is measured by a first diameter monitor; and MP2 indicates a position where the outer diameter is measured by a second diameter monitor.

It is preferable that the following formula (2) be satisfied in the second elongating step:

L(X)<1.5×D1(X) (2)

where L(X) is a distance between the position DS where the outer diameter begins to decrease and the measuring position MP1 where the outer diameter is measured by the diameter monitor 14. In order to feed back to the stretch rate of the intermediate elongated body 21 during elongation, the outer diameter must be measured in the tapered part (between DS and DE) of the intermediate elongated body 21. And, if the speed of the holding part 12 is changed so as to control the outer diameter at the position where the outer diameter is controlled, the outer diameter will change at every deformable position of the intermediate elongated body 21. If the outer diameter measuring position MP1 is provided far apart from the position DS where the intermediate elongated body 21 commences to deform, the change in deformation increases outside the position where the control should primarily be made, and accordingly the elongation controllability decreases. By setting the outer diameter measuring position MP1 in the range where the formula (2) is satisfied, it is possible to achieve elongation with high precision without causing excessive change in the outer diameter at a part that is outside the control position.

Also, in the second elongating step, preferably the first diameter monitor 14 is arranged on the basis of the distance that is determined in the following manner: first, the finished diameter is measured with the second diameter monitor at the post-elongation position MP2 of the intermediate elongated body 21; then, on the basis of the finished diameter thus measured, the above-mentioned distance, which is a distance between the outer diameter measurement position MP1 to be measured with the first diameter monitor 14 and the heating position HP to be heated with the heating source 13, is determined. The optimum outer diameter measurement position MP1 can be determined, regardless of the initial shape, by monitoring the quantity of change in the finished diameter per unit length while changing the distance between the heating source 13 and the outer diameter measurement position MP1, and by finding the position where the fluctuation in the finished diameter becomes smallest.

In the second elongating step, it is also preferable to perform the elongation of the intermediate elongated body 21 while heating the intermediate elongated body 21 so as not to exceed 1500° C. In the method of the present invention for manufacturing the elongated glass body, it is possible to make the heating temperature lower during elongation by making the outer diameter difference, D1(X)−D2(X), between before-elongation and after-elongation to be equal to or less than 500 μm. Thus, by making the surface temperature of the intermediate elongated body 21 to be 1500° C. or less, it is made possible to usefully suppress the vaporization quantity to a lower level and to enhance the precision of the elongation.

When a glass body is elongated using the manufacturing method of an elongated glass body as described above, the desired outer diameter can be achieved at each position along the longitudinal direction of the elongated glass body. More specifically, it is possible to make an elongated glass body in which two times of the standard deviation σ_{D2′(X)-D2(X)} for the difference between the target outer diameter D2(X) and the finished diameter D2′(X) in the longitudinal direction of the effective portion is restrained to 40 μm or less.

### EXAMPLES

Below, more concrete examples will be described. In the first example, the elongation machine 1 shown in FIG. 1 was used in a manner such that a dummy rod was melt-bonded to each end of the glass body 20 and these dummy rods were held by holding parts 11 and 12. The glass body 20, which was mainly made of silica glass, had a columnar shape for elongation, initially having a length of about 600 mm and an outer diameter of 30 mm. The target outer diameter D2(X) of an elongated glass body to be achieved was uniformly set to 10 mm regardless of X in the longitudinal direction.

An oxyhydrogen burner was used as the heating source 13, and the distance between the glass body 20 and the oxyhydrogen burner was set so that the quantity flame-polished by heating (the quantity of the circumferential portion of the glass body that is scraped off by the oxyhydrogen flame) might be smaller. The diameter monitor 14 was arranged on the rear side of the heating source 13 with respect to the onward direction of the heating source 13.

In the first example, the first elongating step was performed dividing into two stages. The glass body 20 (the initial outer diameter: 30 mm) was elongated to have an outer diameter of about 15.0 mm at the first stage, and further elongated to an outer diameter of about 10.3 mm at the second stage to prepare an intermediate elongated body 21. Two times of the standard deviation σ_{D1} of the outer diameter in the effective portion of the intermediate elongated body 21 was 246 μm. Here, the “effective portion” is a part in which the outer diameter is generally stable and which is to be adopted as a product; usually it is the region remaining after removal of about 50 to 100 mm from the elongation starting position.

The intermediate elongated body 21 prepared in the first elongating step was so long that it was divided such that an intermediate elongated body 21 having a length of 500 mm was elongated in the second elongating step. In the second elongating step, the traverse speed of the heating source 13 was set to 5 mm/min. The traverse speed of the holding part 12 was controlled so that the outer diameter as measured by the diameter monitor 14 might be constantly 10.00 mm regardless of X. The distance between the heating position of the heating source 13 and the measurement position of the diameter monitor 14 was set to 5 mm. The hydrogen flow rate of the oxyhydrogen burner, i.e., the heating source 13, was controlled so that the maximum temperature of the surface of the intermediate elongated body 21 might be 1420° C. during elongation.

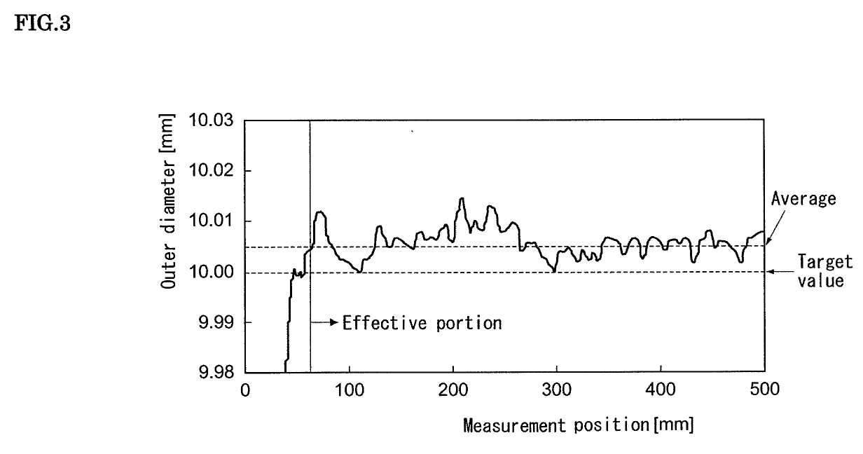

FIG. 3 is a graph showing an outer diameter D2′(X) of each position X along the longitudinal direction of an elongated glass body in the first example. With respect to the target value of 10.00 mmΦ, the difference between the target value and the average of the outer diameter in the effective portion was 5 μm, which indicated the achievement of high precision control, and the value twice the standard deviation σ_{D2′(X)-D2(X)} for the difference between the finished diameter D2′(X) in the effective portion of the elongated glass body and the target outer diameter D2(X) was equal to or less than 12 μm, which was extremely high precision.

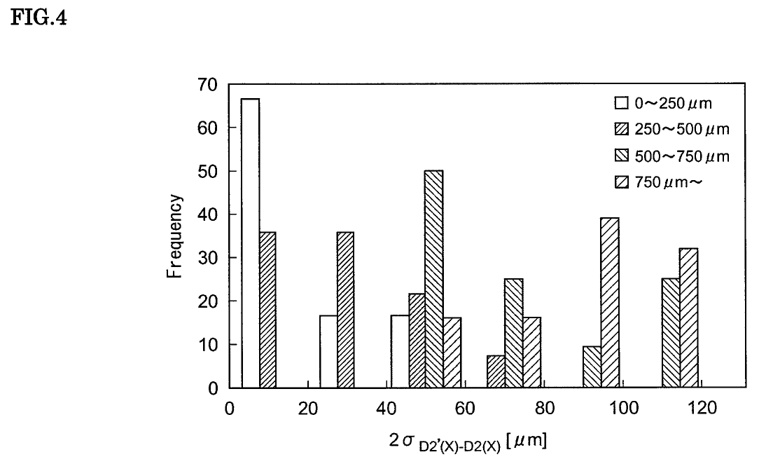

FIG. 4 is a graph showing the frequency distributions of two times of the standard deviation σ_{D2′(X)-D2(X)} for the difference between the target outer diameter D2 (X) and the outer diameter D2′(X) of the elongated glass body in the first example with respect to the cases in which the outer diameter difference, D1(X)−D2, between before-elongation and after-elongation in the second elongating step is less than 250 μm, 250 μm or more and less than 500 μm, 500 μm or more and less than 750 μm, and 750 μm or more. By making the outer diameter difference, D1(X)−D2, between before-elongation and after-elongation in the second elongating step to be 500 μm or less, 2σ_{D2′(X)-D2(X)} of the elongated glass body prepared in the second elongating step can be restrained to 40 μm or less. Also, by making the outer diameter difference, D1(X)−D2, between before-elongation and after-elongation in the second elongating step to 250 μm or less, 2σ_{D2′(X)-D2(X)} of the elongated glass body prepared in the second elongating step can be restrained to 20 μm or less.

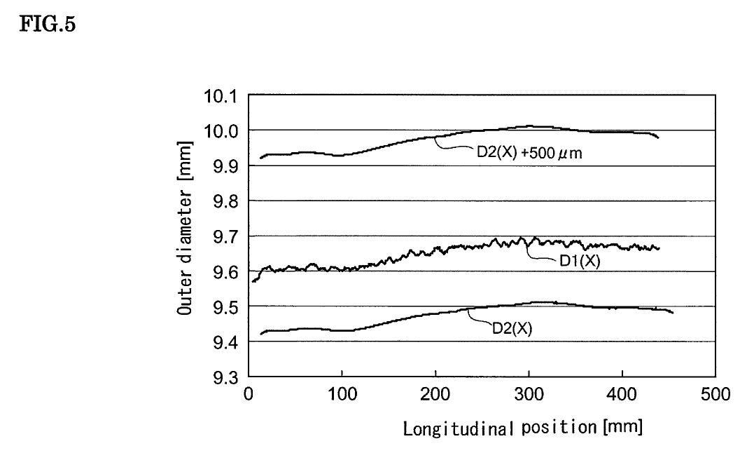

In the second example, the target outer diameter D2(X) that is to be ultimately obtained for the elongated glass body changes depending on X as shown in FIG. 5. In the second example, the first elongating step was also performed dividing into two stages. The glass body 20 (initially, the outer diameter: 21 mm; the length: 350 mm) was elongated to have an outer diameter of about 10.5 mm in the first stage, and further elongated to have an outer diameter of the target value, D2(X), plus 500 μm or less as shown in FIG. 5 in the second stage, and thereby an intermediate elongated body was obtained.

In the second elongating step, the traverse speed of the heating source 13 was set to 3.5 mm/min. The movement speed of the holding part 12 was controlled so that the value of the outer diameter as measured with the diameter monitor 14 might become the target value D2(X) shown in FIG. 5. The distance between the heating position of the heating source 13 and the measurement position of the diameter monitor 14 was set to 4.2 mm. The hydrogen flow rate of the oxyhydrogen burner, i.e., the heating source 13, was controlled so that the maximum temperature on the surface of the intermediate elongated body 21 might become 1350° C. during elongation.

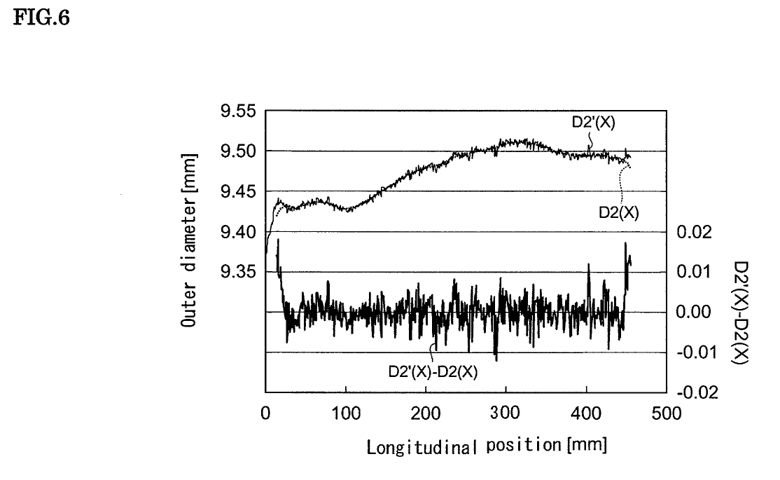

FIG. 6 is a graph showing the target outer diameter D2(X), the finished diameter D2′(X) of the elongated glass body, and the differences between them in the second example. The finished diameter D2′(X) of the elongated glass body obtained by elongating the intermediate elongated body in the second elongating step was well coincident with the target outer diameter D2(X). The value twice the standard deviation σ_{D2′(X)-D2(X)} for the difference between the finished diameter D2′(X) in the effective portion of the elongated glass body and the target outer diameter D2(X) was 8 μm, and the elongation was accomplished with extremely high precision even in the case in which the target outer diameter was not uniform in the longitudinal direction.

The present patent application is based on the Japanese patent application (Patent application No. 2007-166784) filed on Jun. 25, 2007, and its contents are herein incorporated as the reference.

### INDUSTRIAL APPLICABILITY

The elongated glass body manufactured by the method of the present invention is useful as an optical fiber preform.

1. A method of manufacturing an elongated glass body having a target outer diameter by softening and elongating a glass body of columnar or cylindrical shape by means of heating with a heating source movable in a longitudinal direction of the glass body, the method comprising:
a first elongating step for obtaining an intermediate elongated body, where the glass body is softened by heating and elongated, while the outer diameter of the softened part is measured, so that the measured value may become equal to a first controlled diameter, the first controlled diameter being larger than the target outer diameter, where the outer diameter of the intermediate elongated body satisfies the following relationship at each position thereof:
(the target outer diameter−10 μm)<(the outer diameter of the intermediate elongated body)<(the target outer diameter+500 μm);
and
a second elongating step for obtaining an elongated glass body having the target outer diameter, where the intermediate elongated body is softened by heating and elongated, while the outer diameter of the softened part is measured with a first diameter monitor, so that the measure value may coincide with a second controlled diameter, the second controlled diameter being larger than the target outer diameter.

2. A method of manufacturing an elongated glass body according to claim 1, wherein the first elongating step achieves an intermediate elongated body in which the outer diameter of the intermediate elongated body satisfies the following relationship at each position thereof:
(the target outer diameter)<(the outer diameter of the intermediate elongated body)<(the target outer diameter+500 μm).

3. A method of manufacturing an elongated glass body according to claim 2, wherein the distance between the starting position at which the outer diameter of the intermediate elongated body commences to decrease and the position at which the outer diameter is measured by the first diameter monitor is equal to or less than 1.5 times the outer diameter of the intermediate elongated body.

4. A method of manufacturing an elongated glass body according to claim 1, wherein in the second elongating step, a second diameter monitor measures the outer diameter of the part where the intermediate elongated body is elongated, and based on the measured outer diameter of the part where the intermediate elongated body is elongated, the distance between the position heated by the heating source and the position where the outer diameter is measured by the first diameter monitor is determined, and the first diameter monitor is arranged based on the distance thus determined.

5. A method of manufacturing an elongated glass body according to claim 1, wherein in the second elongating step, the temperature of the intermediate elongated body does not exceed 1500° C.
